(19) United States
(12) Patent Application Publication
(10) Pub. No.: US 2019/0231157 A1
(43) Pub. Date: Aug. 1, 2019

(54) DUST GATHERING BOX

(71) Applicant: Jason YAN, New Taipei City (TW)

(72) Inventor: Jason YAN, New Taipei City (TW)

(21) Appl. No.: 16/123,710

(22) Filed: Sep. 6, 2018

(30) Foreign Application Priority Data
Feb. 1, 2018 (TW) 107103595

(51) Int. Cl. A47L 9/10; A47L 9/12; B01D 46/00

(52) U.S. Cl. CPC A47L 9/104; A47L 9/12; B01D 2279/55; A47L 2201/00; B01D 46/0004

(57) ABSTRACT

A dust gathering box is disclosed. The dust gathering box is installed inside a sweeping robot. Dust is sucked into a dust containing space through an air inlet hole. The airtight dust containing space is formed via the engagement of the protruding rim of the box and the first sealing portion as well as the engagement of the protruding rim of the filtering portion and the second sealing portion.

The present application is based on, and claims priority from, Taiwan patent application number TW 107103595, filed 2018 Feb. 1, the disclosure of which is hereby incorporated by reference herein in its entirety.

### BACKGROUND OF THE INVENTION

### Field of the Invention

The invention generally relates to a dust gathering box. More particularly, the invention relates to a dust gathering box which can enhance dust suction effectiveness and performance.

### Description of the Prior Art

In the prior art, generally speaking, the dust gathering box of a sweeping robot has been the best weapon against dust and fine particles. Sweeping robots work by the negative pressure formed in the dust gathering box by the suction fan so as to suck up dust and dirt on or attached to the surfaces of floors, rugs, walls, furniture and other objects; such dust and dirt is collected inside the dust gathering box located inside a sweeping robot.

However, there exists no sealing design between the dust gathering box and its lid and there is no sealing design in other portions of the box. Therefore, the dust suction performance of a sweeping robot is compromised.

### SUMMARY OF THE INVENTION

To eliminate the aforesaid disadvantage, the object of the present invention is to provide an airtight dust gathering box to enable a sweeping robot to suck up dust and fine particles more effectively and thus can enhance the dust suction performance of a sweeping robot.

The dust gathering box of the present invention comprises a box, a dust containing space and a lid. A filtering portion is fitted onto the opening of the box so as to form the dust containing space. An air inlet hole is provided in the bottom of the box so as to allow dust to enter into the dust containing space. The filtering portion is able to filter out micron particles dust, ground dust, dust mites, PM2.5 suspended particles and fine dust. Filtered air may be expelled through an air outlet hole, which is connected with the suction portion of a sweeping robot. The lid is mounted on top of the box to cover the latter's opening. A first sealing portion and a second sealing portion are provided along the perimeter of the lid. The first sealing portion is located on the outer side of the second sealing portion. The protruding rim of the filtering portion is to engage with the second sealing portion. The protruding rim of the box is to engage with the first sealing portion. Therefore, such sealing design enables the dust containing space to be airtight and such airtight dust containing space can enhance the dust suction performance of a sweeping robot.

### BRIEF DESCRIPTION OF THE DRAWINGS

FIG. 1 is a perspective view of the dust gathering box of the present invention.

FIG. 2 is an exploded view of the dust gathering box of the present invention.

FIG. 3 is a perspective view of the lid of the dust gathering box of the present invention.

FIG. 4 is a sectional view of the dust gathering box of the present invention.

### DETAILED DESCRIPTION OF THE INVENTION

Although a preferred embodiment of the present invention will be described in detail in the following, it should be understood that the preferred embodiment and the accompanying drawings should be regarded in an illustrative manner rather than a restrictive manner.

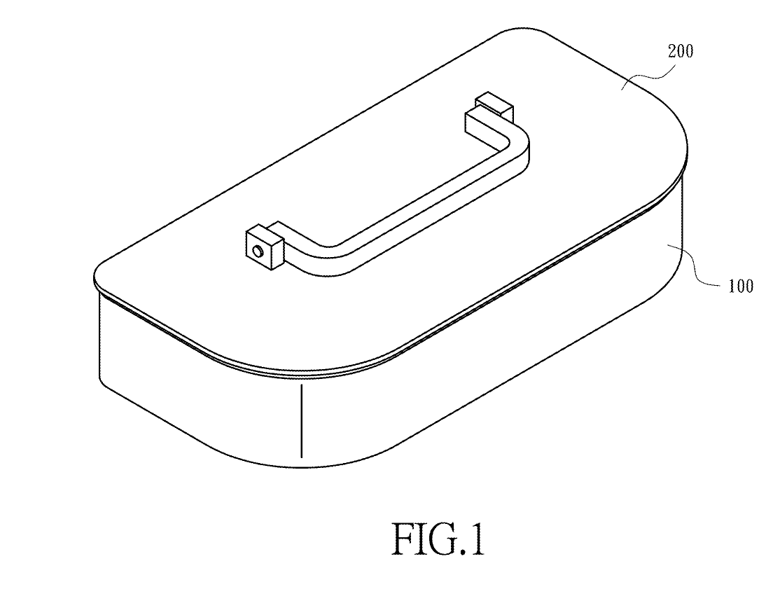

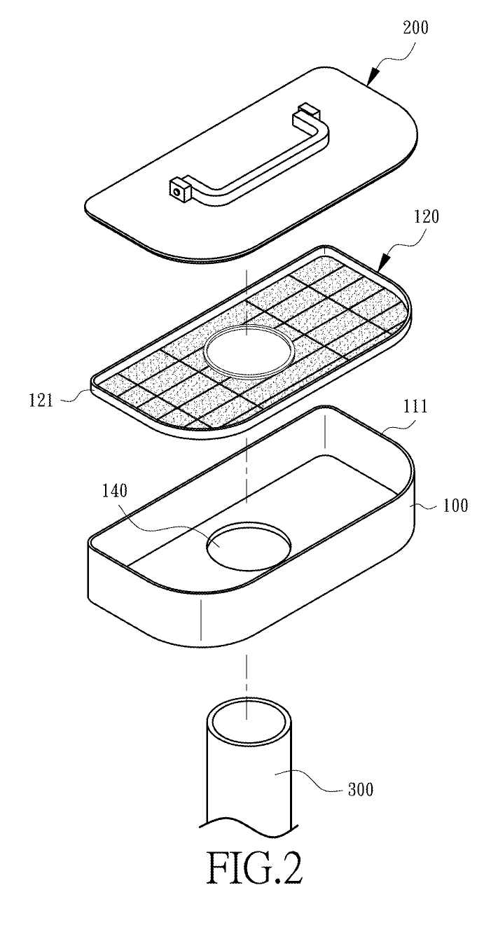

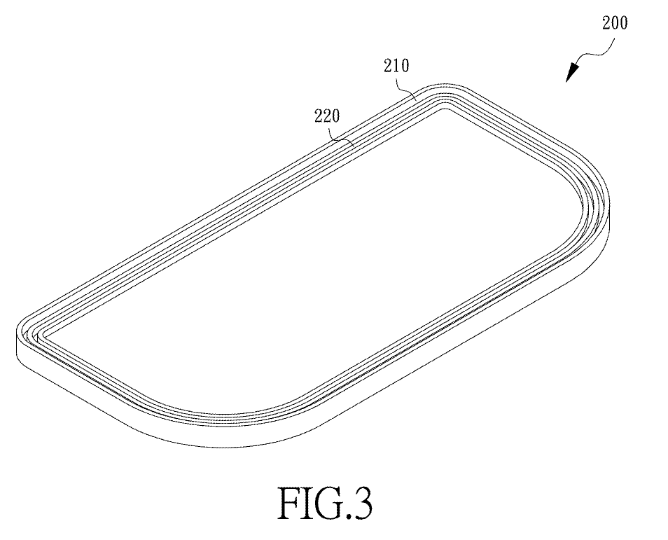

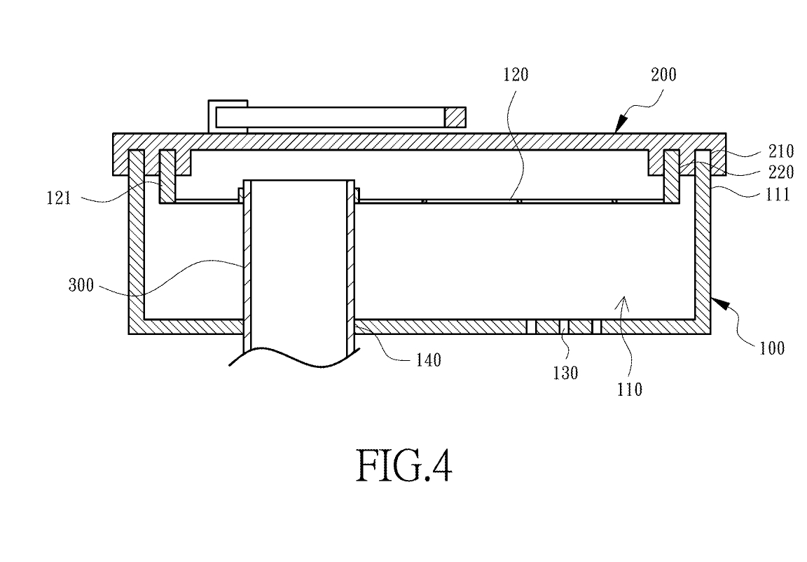

Please refer to FIGS. 1 to 4. The dust gathering box of the present invention comprises a box 100, a dust containing space 110 and a lid 200. A filtering portion 120 is fitted onto the opening of the box 100 so as to form the dust containing space 110. An air inlet hole 130 is provided in the bottom of the box 100 so as to allow dust to enter into the dust containing space 110. The filtering portion 120 is able to filter out micron particles dust, ground dust, dust mites, PM2.5 suspended particles and fine dust. Filtered air may be expelled through an air outlet hole 140, which is connected with the suction portion 300 of a sweeping robot. The lid 200 is mounted on top of the box 100 to cover the latter's opening. A first sealing portion 210 and a second sealing portion 220 are provided along the perimeter of the lid 200. The first sealing portion 210 is located on the outer side of the second sealing portion 220. The protruding rim 121 of the filtering portion 120 is to engage with the second sealing portion 220. The protruding rim 111 of the box 100 is to engage with the first sealing portion 210. Therefore, such sealing design enables the dust containing space to be airtight and such airtight dust containing space can enhance the dust suction performance of the sweeping robot.

As the dust gathering box of the present invention is used, such airtightness enables the air to move more effectively and quickly inside the dust gathering space and thus can enhance its dust suction performance.

Although a preferred embodiment of the present invention has been described in detail hereinabove, it should be understood that the preferred embodiment is to be regarded in an illustrative manner rather than a restrictive manner, and all variations and modifications of the basic inventive concepts herein taught still fall within the scope of the present invention.

From the above, we can see that the dust gathering box of the present invention meets the relevant patent requirements. It is hoped that the patent application will be approved.

What is claimed is:

1. A dust gathering box, comprising:
a box, having an opening and a dust containing space, characterized in that an air inlet hole and an air outlet hole are provided in the bottom of the box, and that dust is sucked into dust containing space through the air inlet hole;
a filtering portion, fitted onto the opening of the box so as to form the dust containing space, characterized in that the filtering portion is able to filter out dust mites and fine dust; and
a lid, mounted on top of the box to cover the latter's opening, characterized in that a first sealing portion and a second sealing portion are provided along the perimeter of the lid.

2. The dust gathering box as in claim 1, characterized in that the first sealing portion is located on the outer side of the second sealing portion.

3. The dust gathering box as in claim 1, characterized in that the protruding rim of the box is to engage with the first sealing portion to form an airtight dust containing space.

4. The dust gathering box as in claim 1, characterized in that the protruding rim of the filtering portion is to engage with the second sealing portion.

5. The dust gathering box as in claim 1, characterized in that the air outlet hole is connected with the suction portion of a sweeping robot.
